(19) United States
(12) Patent Application Publication
(10) Pub. No.: US 2025/0322681 A1
(43) Pub. Date: Oct. 16, 2025

(54) LLM-DRIVEN SYSTEM TO GENERATE DESCRIPTIONS OF MANUFACTURING PROCESSES IN REAL-TME

(71) Applicant: Dell Products L.P., Round Rock, TX (US)

(72) Inventors: Vinicius Facco Rodrigues, São Paulo (BR); Joubert de Castro Lima, Cataguases (BR); Fabricio Matheus Takaki, Valinhos (BR)

(21) Appl. No.: 18/635,759

(22) Filed: Apr. 15, 2024

(51) Int. Cl. G06V 20/70; G06F 40/40; G06Q 50/04; G06T 7/00; G06V 10/70; G06V 20/50; G09B 5/02

(52) U.S. Cl. CPC G06V 20/70; G06F 40/40; G06T 7/0004; G06V 10/70; G06V 20/50; G09B 5/02; G06Q 50/04; G06T 2207/10024; G06T 2207/10028; G06T 2207/30108

(57) ABSTRACT

One example method includes collecting a single image frame of a workstation where a manufacturing step of a manufacturing process is performed. One or more objects and/or one or more actions in the single image frame are then detected. A first text description of the single image frame is generated based on the one or more detected objects and/or the one or more actions. The first text description of the single image frame is concatenated with previously generated second text descriptions of previously collected single image frames. The concatenation of the first text description and the previously generated second text descriptions are provided to a Large Language Model (LLM) to thereby cause the LLM to generate a text description of a scene that is representative of the manufacturing step in the manufacturing process. The text description of the scene is analyzed and visualized in real-time.

### TECHNOLOGICAL FIELD OF THE DISCLOSURE

Embodiments disclosed herein generally relate to manufacturing processes. More particularly, at least some embodiments relate to systems, hardware, software, computer-readable media, and methods for implementing a Large Langue Model (LLM) to generate descriptions of the manufacturing process in real-time.

### BACKGROUND

As part of the supply chain process, the manufacturing process is very complex and depends on an end-to-end coordination. For instance, during the assembly process each operator must follow a set of instructions to maintain the production line performance health and the product's quality. However, several factors, including human well-being and lack of skills, might result in bottlenecks that can impact an entire production line, thus reducing the manufacturing performance.

Early detecting, reporting, and acting to avoid such bottlenecks is crucial to improve key performance indicators such as productivity, quality, cost reduction and time-to-market. However, there are many current challenges when it comes to monitoring and reporting the manufacturing process in real-time. Current strategies rely on monitoring specific key performance indicators, such as the number of units produced in a time, which does not highlight the root causes of a performance loss. More advanced strategies employ computer vision solutions to record and detect actions and objects in real-time for a more granular analysis. Nevertheless, such strategies still depend on post-processing and analysis to identify potential problems, which increases the response time to make corrections in the process.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a system that implements a Large Langue Model (LLM) to generate descriptions of a manufacturing process in real-time;

FIGS. 2A-2F discloses aspects of a process flow of the system of FIG. 1; and

FIG. 3 discloses an example computing entity configured to perform any of the disclosed methods, processes, and operations.

### DETAILED DESCRIPTION OF SOME EXAMPLE EMBODIMENTS

Embodiments disclosed herein generally relate to manufacturing processes. More particularly, at least some embodiments relate to systems, hardware, software, computer-readable media, and methods for implementing a Large Langue Model (LLM) to generate descriptions of the manufacturing process in real-time.

One example method includes collecting a single image frame of a workstation where a manufacturing step of a manufacturing process is performed. One or more objects and/or one or more actions in the single image frame are then detected. A first text description of the single image frame is generated based on the one or more detected objects and/or the one or more actions. The first text description of the single image frame is concatenated with previously generated second text descriptions of previously collected single image frames. The concatenation of the first text description and the previously generated second text descriptions are provided to a Large Language Model (LLM) to thereby cause the LLM to generate a text description of a scene that is representative of the manufacturing step in the manufacturing process. The text description of the scene is analyzed and visualized in real-time.

The embodiments disclosed herein may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The embodiments disclosed herein, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The embodiments disclosed herein define a video streaming processing pipeline to generate real-time descriptions of a production process in a workstation. One embodiment comprises four main modules: (i) frame collector-data collection from a camera device; (ii) frame to text descriptor-conversion of a single frame to text description; (iii) LLM generative process descriptor-combination of multiple descriptions in prompt to a fine-tuned LLM to generate the process description; and (iv) real-time monitor-real-time visualization and analysis of the process description.

A workstation is the place in a manufacturing process where a human operator or a robot perform a specific set of tasks from an entire manufacturing process. Those tasks should follow specific instructions defined by the manufacturing process engineers and any deviation should be corrected as soon as possible. In the embodiments disclosed here, the following processing pipeline takes place:
1. A camera device captures several frames from a workstation process according to a frame rate (it will depend on the shortest task duration) which are collected by the frame collector.
2. Each frame is then processed by the frame to text descriptor that generates a text description of objects and actions detected in the frame.
3. The LLM generative process descriptor processes the current image frame description combining it with the descriptions of the last i recent frame descriptions sequentially. It employs prompt engineering strategies to compose a prompt concatenating tokens from a sequence of frames and queries a pretrained LLM to generate the current scene process summarization.
4. The real-time monitor outputs the current process detected and signalizes whether this is part of the process, of a deviation from it that should be corrected.

The LLM generative process descriptor enables the process detection in the pipeline. The module comprises three elements: (i) short-term cache; (ii) composable prompt builder; and (iii) pretrained LLM. The module receives single-frame descriptions from the frame to text descriptor module in real-time. A frame description is composed of a set of words defining the detected objects and actions in the current image frame. At each received description, the short-term cache stores the last j descriptions to be used by the composable prompt builder. The composable prompt builder processes each new single-frame description by concatenating it with the last j cached descriptions. The composable prompt builder employs a prompt engineering strategy, such as zero-shot learning, to build the prompt to a pretrained encoder-decoder LLM that summarizes the current process. The summarization comprises the current process and the tools being used.

The system feedback provides real-time manufacturing process detection that can be applied for real-time visualization in the workstation or processed by external services/systems to provide insights and statistics for managers and engineering groups. The real-time monitor constantly compares the detected process with the expected process to raise alarms when identifying inconsistencies.

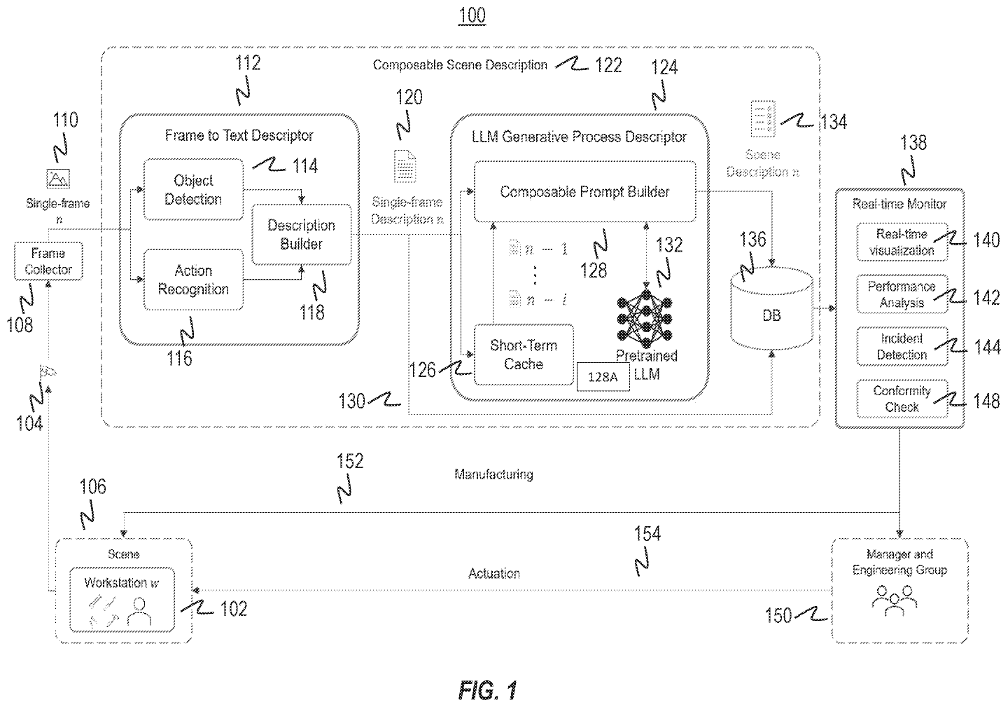

FIG. 1 illustrates an embodiment of a system 100 where the embodiments disclosed herein may be practiced. As illustrated, the system 100 includes a workstation w 102 that is used in manufacturing process. In the illustrated embodiment, the workstation w 102 is workstation for a human worker that is involved in computer manufacturing process. Thus, the workstation w 102 includes tools such as wrenches and screwdrivers that may be used in the manufacturing process. It will be appreciated that the workstation w 102 can be used in any reasonable manufacturing process and can be a workstation for a non-human worker such as robot. In addition, there can be more than one human or non-human worker who use the workstation w 102.

The workstation w 102 is monitored by a camera 104 to record a scene 106 of the activities of the human worker while he or she is working at the workstation w 102. The camera 104 may be any reasonable camera that is able to generate RGB and/or depth images of the scene 106. Accordingly, the embodiments disclosed herein are not limited by any specific type of camera 104.

The system 100 includes a frame collector module 108, which may be implemented as reasonable frame collection machine-learning (ML) model or other suitable control software or firmware. In operation, the frame collector module 108 acquires the RGB and/or depth images from the camera 104. In one embodiment, the frame collector module 108 acquires the current image frame n 110 from the camera 104 at each time interval defined by f (seconds), where f=1/frames_per_second. This process is continually repeated so that the frame collector module 108 is continually acquiring the current image frame n 110 from the camera 104.

The system 100 includes a frame to text descriptor module 112 and a Large Langue Model (LLM) generative process descriptor module 124, which together generate a composable scene description 122 as will be explained. The frame to text descriptor module 112 includes an object detection model 114 and an action recognition model 116. The objection detection model 114 can be any reasonable object recognition ML model or other object recognition algorithm that is able to process the received current image frame n 110. Likewise, the action recognition model 116 can be any reasonable action recognition ML model or other action recognition algorithm that is able to process the received current image frame n 110. In operation, the object detection model 114 detects objects in the received current image frame n 110 and the action recognition model 116 recognizes actions in the received current image frame n 110.

The objects detected by the object detection model 114 and the action recognition model 116 are provided to a description builder model 118, which can be any reasonable ML model or other algorithm. In operation, the description builder model 118 is able to generate a text representation of the current image frame n 110 in string format based on the output of the object detection model 114 and the action recognition model 116. This is shown as single-frame description n 120 in FIG. 1. As shown at 130, the frame to text descriptor module 112 provides the single-frame description n 120 to a database 136 for visualization purposes as will be explained in more detail to follow, future use in other algorithms, and statistical purposes and also provides the single-frame description n 120 to the LLM generative process descriptor module 124.

The LLM generative process descriptor module 124 includes a short-term cache 126 that caches the last i single-frame descriptions n 120 and stores each new arriving frame description. When the number of single-frame descriptions n 120 reaches the predetermined value of i, the oldest frame description is removed from the short-term cache 126. For example, if i was equal to 10, then when the 11th single-frame description n 120 was received, the oldest single-frame description n 120 in the short-term cache 126 would be removed. In this way, the frame descriptions are kept up to date.

The LLM generative process descriptor module 124 includes a composable prompt builder 128, which can be any reasonable prompt building ML model or other algorithm. When the short-term cache 126 contains at least i single-frame descriptions (when the system starts the short-term cache 126 is empty), for each new arriving single-frame description n 120, the composable prompt builder 128 concatenates all the single-frame descriptions n 120 in the short-term cache 126 and adds a prompt template to the concatenated frame descriptions. The composable prompt builder 128 employs any reasonable prompt engineering strategy to generate a prompt 128A for a pretrained LLM 132.

The pretrained LLM 132, which can be any reasonable LLM ML model, generates a text scene description n 134 from a prompt engineering strategy of the composable prompt builder 128 that can be either a classification tag or a summarization text. The text scene description n 134 is then provided to the database 136 for storage and further use.

An LLM foundation model can be pretrained for a specific task using work instructions documents which already exist to document and describe a manufacturing process. For instance, the following simplified work instruction defines the process of installing a motherboard in a personal computer in a workstation from a production line:
1. Drag the tray to the workstation.
2. Unscrew the screws_a1.
3. Remove the computer chassis cover.
4. Place the motherboard inside the chassis.
5. Screw the screws_b1 to fix the motherboard.
6. Plug the motherboard cable.
7. Push the tray to the next workstation.

Work instructions describe the steps to build a product in the manufacturing line, which include a specific label. The composable prompt builder 128 can also use the work instruction steps in the prompt employing a prompt engineering strategy, such as zero-shot learning, also giving the steps to be predicted.

By fine-tuning the pretrained LLM 132 to classify text containing objects and actions, it is possible to feed a sequence of frames descriptions prompting for a manufacturing step classification or summarization. For instance, the pretrained BERT model can be fine-tuned to perform a classification task. The prompt strategy uses a prompt template that includes the concatenated frame descriptions discussed previously. For instance, the following prompt 128A can be used with the concatenated frame descriptions:
“determine the manufacturing phase from the following sequence of objects and activities detected:
{descriptions}”

The possible target classes (work instruction steps) can also be used in the prompt 128A to lead the pretrained LLM 132 to generate the probability scores for each one:
“consider the following sequence of objects and actions detected:
{descriptions}
detect which step is being performed from the following list:
{steps}”

The use of a caching system to build a sequence of objects and actions detected across several frames allows the prompt 128A to include the context of the process in a given p seconds time window, where p=f×i. This strategy allows the pretrained LLM 132 to evaluate the process not only using single detection entities, but also the sequence of detection entities. The “description” in the prompt template gets replaced with these descriptions and the pretrained LLM 132 generates a step classification as the text scene description n 134. The resulting text classification represents the description of the current step in the manufacturing process or the step with the higher probability (depending on the strategy). Alternatively, the prompt 128A could also leverage a few-shot learning strategy by including some samples of objects and activities in sequence and their process step.

The system 100 includes a real-time monitor module 138. In operation, the real-time monitor module 138 uses each text scene description n 134 for various monitoring tasks. For example, the real-time monitor module 138 can provide real-time visualization 140 of the scene 106 of the workstation w 102. The real-time visualization 140 can be provided to the worker at the workstation w 102 as shown at 152 and can also be provided to a management and engineering group 150 for further analysis.

The real-time monitor module 138 also uses each text scene description n 134 together with any process instruction documentation to provide performance analysis 142, incident detection 144, and/or conformity checks 148. For example, the performance analysis 142 can determine if the manufacturing process was completed given p seconds time window. The incident detection can determine if an adverse incident such as a worker injury has occurred. The conformity check 148 can determine if the manufacturing process has conformed to the expected parameters. As shown, the performance analysis 142, incident detection 144, and/or conformity checks 148 can be provided to the management and engineering group 150 for further analysis. Such further analysis can then be provided to the worker at the workstation w 102 as shown at 154.

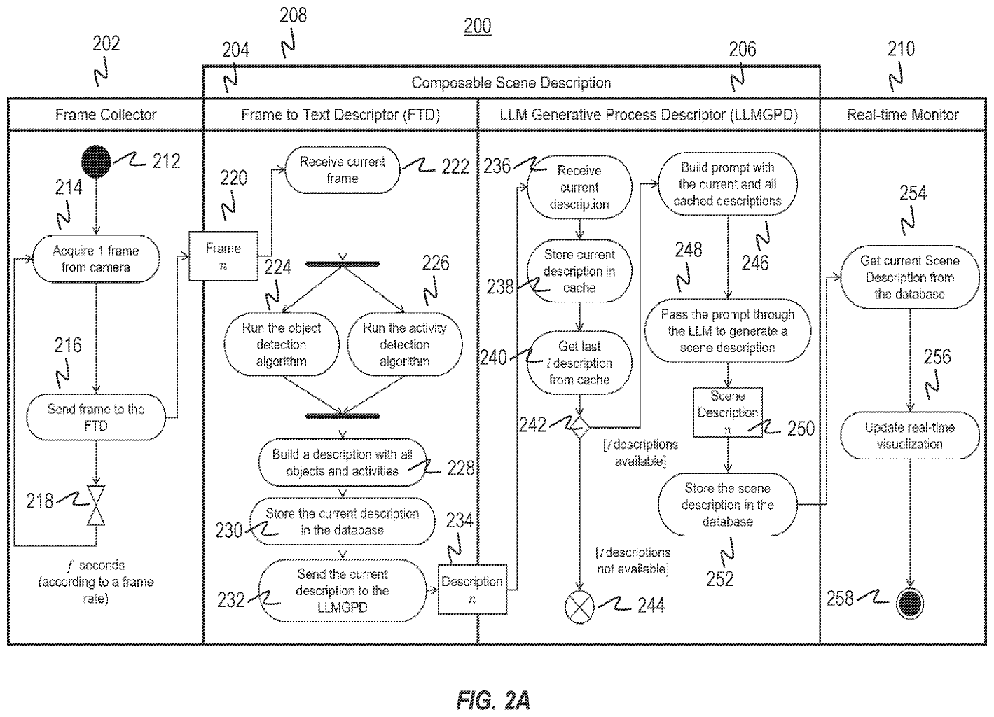

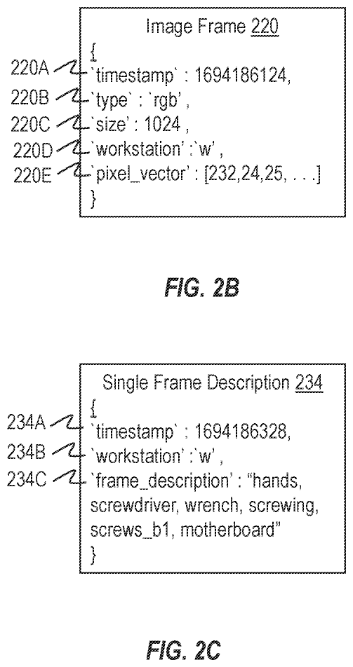

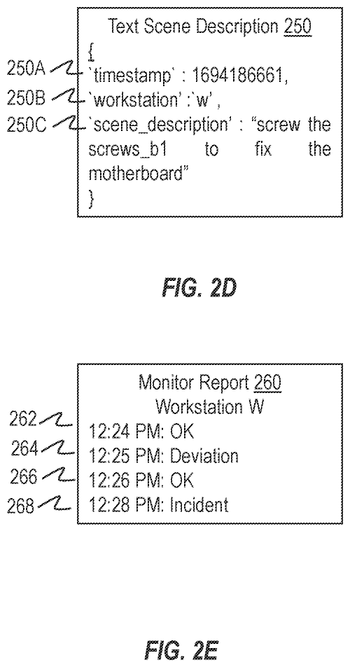

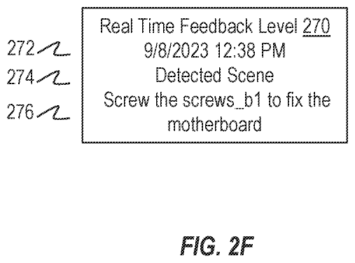

FIG. 2A illustrates an embodiment of a process flow 200 of an example use case of the system 100 of FIG. 1. As shown in FIG. 2A, some of the steps of the process flow are performed at a frame collector module 202 that corresponds to the frame collector module 108, a frame to text descriptor module 204 that corresponds to the frame to text descriptor module 112, a LLM generative process descriptor module 206 that corresponds to the LLM generative process descriptor module 124 (where the frame to text descriptor module 204 and the LLM generative process descriptor module 124 comprise a composable scene description module 208 that correspond to the composable scene description 122), and a real-time monitor module 210 that corresponds to the real-time monitor module 138.

The process flow begins at step 212. At step 214 the frame collector module 202 acquires a current image frame n 220, which corresponds to the current image frame n 110, from the camera 104. At step 216, the image frame n 220 is sent to the frame to text descriptor module 204. As shown at step 218, the current image frame n 220 is acquired from the camera at each time interval defined by f (seconds), where f=1/frames_per_second.

FIG. 2B illustrates an embodiment of the current image frame n 220. As illustrated, the embodiment of the current image frame n 220 includes a time stamp 220A indicating the time that the current image frame n 220 was captured by the camera 104, an indication 220B of the type of the camera 104, which in the embodiment is an RGB camera, a frame size indication 220C, an indication 220D that workstation w 102 is the subject of the image frame, and a pixel vector value 220E.

Returning to FIG. 2A, at step 222 the current image frame n 220 is received by the frame to text descriptor module 204. At step 224 the object detection module 114 performs object detection on the current image frame n 220. At step 226 the action recognition module 116 performs action recognition on the current image frame n 220. At step 228 the description builder model 118 generates a text representation of the current image frame n 220 in string format based on the output of the object detection model 114 and an action recognition model 116. This is shown as single-frame description n 234, which corresponds to the single-frame description n 120. At step 230, the single-frame description n 234 is stored in the database 136. At step 232 the single-frame description n 234 is sent to the LLM generative process descriptor module 206.

FIG. 2C illustrates an embodiment of the single-frame description n 234. As illustrated, the embodiment of the single-frame description n 234 includes a time stamp 234A indicating the time that the single-frame description n 234 was generated by the description builder model 118, an indication 234B that workstation w 102 is the subject of the single-frame description n 234, and a frame description 234C that describes in text format the contents of the current image frame n 220. In the illustrated embodiment, since work being performed at the workstation w 102 is a computer manufacturing process the frame description 234C lists “hands, screwdriver, wrench, screwing, screws_b1, motherboard” since these are items used in the computer manufacturing process.

Returning to FIG. 2A, at step 236 the LLM generative process descriptor module 206 receives the single-frame description n 234. At step 238 the single-frame description n 234 is stored in the short-term cache 126. At step 240, the composable prompt builder 128 gets the last i single-frame description in the short-term cache 126. If there are not i single-frame descriptions available (No in decision step 242), then the process waits until i single-frame descriptions available as shown at step 244. For example, if i is equal to 10, the system will not move forward until at least 10 single-frame descriptions (when the system starts the short-term cache 126 is empty) are stored in the short-term cache 126.

However, when the short-term cache 126 contains i single-frame descriptions (Yes in decision step 242), at step 246 the composable prompt builder 128 will build the prompt 128A based on the concatenation of the current single-frame description n 234 and all those cached in the short-term cache 126 in the manner previously described. At step 248, the prompt 128A is passed pretrained LLM 132, which generates a text scene description n 250, which corresponds to the text scene description n 134. The text scene description n 250 is then stored in the database 136 at step 252.

FIG. 2D illustrates an embodiment of the text scene description n 250. As illustrated, the embodiment of the text scene description n 250 includes a time stamp 250A indicating the time that the text scene description n 250 was generated by the pretrained LLM 132, an indication 250B that workstation w 102 is the subject of the text scene description n 250, and a scene description 250C that describes in text format the contents of the current scene 106. In the illustrated embodiment, since work being performed at the workstation w 102 is a computer manufacturing process scene description 250C states “screw the screws_b1 to fix the motherboard” since this is the current step in the computer manufacturing process that should be performed by the worker at the workstation w 102.

Returning to FIG. 2A, at step 254 the text scene description n 250 is received by the real-time monitor module 210 from the database 136. At step 256 the real-time monitor module 210 is able to update the real-time visualization 140, provide performance analysis 142, incident detection 144, and/or conformity checks 148. At step 258 the process flow ends.

FIG. 2E illustrates an embodiment of a monitor report 260 for the workstation w 102 that is generated by the real-time monitor module 210 as part of its operation. The monitor report 260 can be provided to the management and engineering group 150 for further analysis. For example, the monitor report 260 may indicate at a time 262 that everything is OK with the manufacturing process.

However, at a time 264, there may be an indication of a deviation. The deviation may be caused by a step in the process taking longer than expected or a worker adding a step to the manufacturing process in order to complete the. If these deviations continue, then the management and engineering group 150 may determine that more time is needs to allotted to the process step or that additional steps are needed for the worker to successfully complete the process. The embodiments described herein provide this deviation information in real-time to the management and engineering group 150.

At a time 266 the monitor report 260 may indicate at a time 262 that everything is OK with the manufacturing process. At a time 268, the monitor report 260 may indicate that an incident has occurred. This incident may be a worker accident that needs immediate attention, or it could be a failure somewhere in the manufacturing process. Again, the embodiments described herein provide this incident information in real-time to the management and engineering group 150. In some embodiments the monitor report 260 can also be compared to an expected manufacturing step and a timeline in monitor report 260 can demonstrate a sequence of events to the management and engineering group 150 as they monitor several workstations.

FIG. 2F illustrates real-time feedback 270 that can be provided to the worker at the workstation w 102 by the real-time monitor module 210. As illustrated, the real-time feedback 270 includes date and time information 272, a description 274 of the detected scene, and real-time instructions 276 to the worker. In the embodiment, the real-time instructions 276 to the worker state “screw the screws_b1 to fix the motherboard”. In this way, the worker is told what action should be performed during this step of the manufacturing process. Thus, the worker is able to perform the action to keep the manufacturing process moving along.

In some embodiments the real-time feedback 270 may include a color indication to the worker that shows if the process step has been correctly completed. For example, a green color indication can show that the process step has been correctly completed. A yellow color indication can show that there are minor errors in the process step. A red color indication can show that the process has not been correctly completed. In the case of the yellow or red color indication, the worker may be prompted to follow the real-time instructions 276 more closely so that the process step can be correctly completed.

Following are some further example embodiments of the invention. These are presented only by way of example and are not intended to limit the scope of the invention in any way.

Embodiment 1. A method comprising: collecting a single image frame of a workstation where a manufacturing step of a manufacturing process is performed; detecting one or more objects and/or one or more actions in the single image frame; generating a first text description of the single image frame based on the one or more detected objects and/or the one or more actions; concatenating the first text description of the single image frame with a plurality of previously generated second text descriptions of previously collected single image frames; providing the concatenation of the first text description and the plurality of previously generated second text descriptions to a Large Language Model (LLM) to thereby cause the LLM to generate a text description of a scene that is representative of the manufacturing step in the manufacturing process; and analyzing and visualizing the text description of the scene in real-time.

Embodiment 2. The method as recited in embodiment 1, wherein the single image frame is collected by an RGB or a depth camera that is configured to monitor the workstation where the manufacturing step of the manufacturing process is performed.

Embodiment 3. The method as recited in any of embodiments 1-2, wherein the LLM is pretrained using a description of the manufacturing process that includes the manufacturing step.

Embodiment 4. The method as recited in any of embodiments 1-3, wherein providing the concatenation of the first and second text descriptions comprises: generating a prompt based on the concatenation; and providing the prompt to the LLM.

Embodiment 5. The method as recited in any of embodiments 1-4, The method of claim 1, wherein analyzing and visualizing the text description of the scene in real-time comprises one or more of: generating a real-time visualization of the scene; performing performance analysis of the scene; performing indent detection in the scene; and performing a conformity check of the scene.

Embodiment 6. The method as recited in any of embodiments 1-5, wherein one or more of the real-time visualization, the performance analysis, the incident detection, and the conformity check are provided to a management and engineering group for further analysis.

Embodiment 7. The method as recited in any of embodiments 1-6, wherein the real-time visualization of the scene is provided to a worker who is performing the manufacturing step of the manufacturing process at the workstation, the real-time visualization providing instructions on how to perform the manufacturing step in the manufacturing process to the worker.

Embodiment 8. The method as recited in any of embodiments 1-7, wherein the first text description and the plurality of previously generated second text descriptions are stored in a short-term cache prior to being concatenated.

Embodiment 9. The method as recited in any of embodiments 1-8, wherein the short-term cache is initially empty and the first text description and the plurality of previously generated second text descriptions are not concatenated until a predetermined number of first and second text descriptions have been stored in the short-term cache.

Embodiment 10. The method as recited in any of embodiments 1-9, wherein the first text description and the text description of the scene are stored in a database prior to analyzing and visualizing the text description of the scene in real-time.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

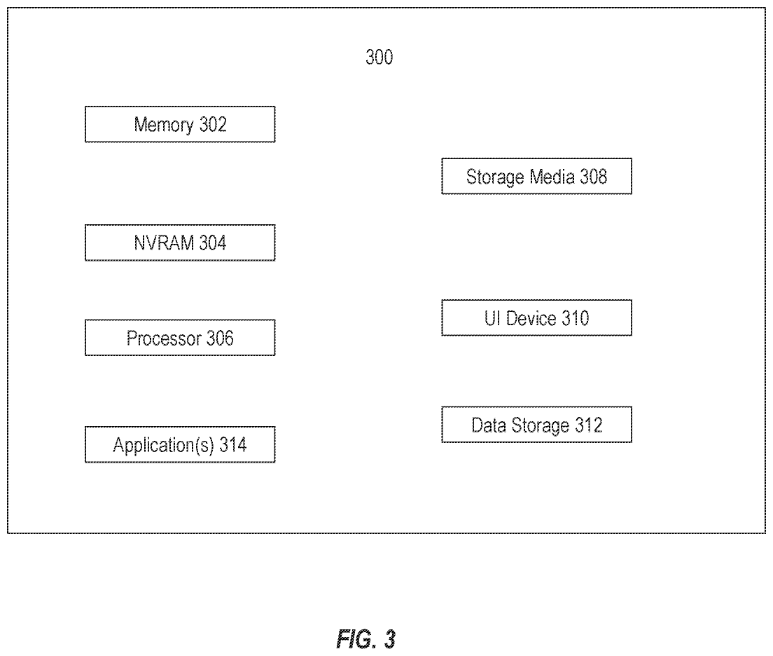

With reference briefly now to FIG. 3, any one or more of the entities disclosed, or implied, by FIGS. 1-2F, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
collecting a single image frame of a workstation where a manufacturing step of a manufacturing process is performed;
detecting one or more objects and/or one or more actions in the single image frame;
generating a first text description of the single image frame based on the one or more detected objects and/or the one or more actions;
concatenating the first text description of the single image frame with a plurality of previously generated second text descriptions of previously collected single image frames;
providing the concatenation of the first text description and the plurality of previously generated second text descriptions to a Large Language Model (LLM) to thereby cause the LLM to generate a text description of a scene that is representative of the manufacturing step in the manufacturing process; and
analyzing and visualizing the text description of the scene in real-time.

2. The method of claim 1, wherein the single image frame is collected by an RGB or a depth camera that is configured to monitor the workstation where the manufacturing step of the manufacturing process is performed.

3. The method of claim 1, wherein the LLM is pretrained using a description of the manufacturing process that includes the manufacturing step.

4. The method of claim 1, wherein providing the concatenation of the first and second text descriptions comprises:
generating a prompt based on the concatenation; and
providing the prompt to the LLM.

5. The method of claim 1, wherein analyzing and visualizing the text description of the scene in real-time comprises one or more of:
generating a real-time visualization of the scene;
performing performance analysis of the scene;
performing incident detection in the scene; and
performing a conformity check of the scene.

6. The method of claim 5, wherein one or more of the real-time visualization, the performance analysis, the incident detection, and the conformity check are provided to a management and engineering group for further analysis.

7. The method of claim 5, wherein the real-time visualization of the scene is provided to a worker who is performing the manufacturing step of the manufacturing process at the workstation, the real-time visualization providing instructions on how to perform the manufacturing step in the manufacturing process to the worker.

8. The method of claim 1, wherein the first text description and the plurality of previously generated second text descriptions are stored in a short-term cache prior to being concatenated.

9. The method of claim 8, wherein the short-term cache is initially empty and the first text description and the plurality of previously generated second text descriptions are not concatenated until a predetermined number of first and second text descriptions have been stored in the short-term cache.

10. The method of claim 1, wherein the first text description and the text description of the scene are stored in a database prior to analyzing and visualizing the text description of the scene in real-time.

11. A non-transitory storage medium having stored therein instructions that are executable by one or more hardware processors to perform operations comprising:
collecting a single image frame of a workstation where a manufacturing step of a manufacturing process is performed;
detecting one or more objects and/or one or more actions in the single image frame;
generating a first text description of the single image frame based on the one or more detected objects and/or the one or more actions;
concatenating the first text description of the single image frame with a plurality of previously generated second text descriptions of previously collected single image frames;
providing the concatenation of the first text description and the plurality of previously generated second text descriptions to a Large Language Model (LLM) to thereby cause the LLM to generate a text description of a scene that is representative of the manufacturing step in the manufacturing process; and
analyzing and visualizing the text description of the scene in real-time.

12. The non-transitory storage medium of claim 11, wherein the single image frame is collected by an RGB or a depth camera that is configured to monitor the workstation where the manufacturing step of the manufacturing process is performed.

13. The non-transitory storage medium of claim 11, wherein the LLM is pretrained using a description of the manufacturing process that includes the manufacturing step.

14. The non-transitory storage medium of claim 11, wherein providing the concatenation of the first and second text descriptions comprises:
generating a prompt based on the concatenation; and
providing the prompt to the LLM.

15. The non-transitory storage medium of claim 11, wherein analyzing and visualizing the text description of the scene in real-time comprises one or more of:
generating a real-time visualization of the scene;
performing performance analysis of the scene;
performing incident detection in the scene; and
performing a conformity check of the scene.

16. The non-transitory storage medium of claim 15, wherein one or more of the real-time visualization, the performance analysis, the incident detection, and the conformity check are provided to a management and engineering group for further analysis.

17. The non-transitory storage medium of claim 15, wherein the real-time visualization of the scene is provided to a worker who is performing the manufacturing step of the manufacturing process at the workstation, the real-time visualization providing instructions on how to perform the manufacturing step in the manufacturing process to the worker.

18. The non-transitory storage medium of claim 11, wherein the first text description and the plurality of previously generated second text descriptions are stored in a short-term cache prior to being concatenated.

19. The non-transitory storage medium of claim 18, wherein the short-term cache is initially empty and the first text description and the plurality of previously generated second text descriptions are not concatenated until a predetermined number of first and second text descriptions have been stored in the short-term cache.

20. The non-transitory storage medium of claim 11, wherein the first text description and the text description of the scene are stored in a database prior to analyzing and visualizing the text description of the scene in real-time.
